(19) United States
(12) Patent Application Publication
(10) Pub. No.: US 2012/0139751 A1
(43) Pub. Date: Jun. 7, 2012

(54) Tire-Pressure Signal Transmitting Device

(76) Inventor: Chih-Hen Lin, Taipei City (TW)

(21) Appl. No.: 12/957,449

(22) Filed: Dec. 1, 2010

(51) Int. Cl. H04Q 9/00

(52) U.S. Cl. 340/870.07

(57) ABSTRACT

A tire-pressure signal transmitting device includes a tire pressure detector mounted in a tire of a vehicle. The tire pressure detector detects pressure in the tire. A transmitting device includes a data receiver and a wireless transmitter. The data receiver receives data containing pressure of the tire detected by the tire pressure detector. The wireless transmitter is connected to the data receiver by a transmission interface. The transmission interface converts the data from the data receiver into a signal indicative of the data and transmits the signal to the wireless transmitter. The wireless transmitter sends out the signal indicative of the data. A portable electronic device receives the signal sent by the wireless transmitter, allowing a user of the portable electronic device to know the pressure of the tire.

### BACKGROUND OF THE INVENTION

The present invention relates to a tire-pressure signal transmitting device and, more particularly, to a tire-pressure signal transmitting device for transmitting the pressure and temperature of a vehicular tire and displaying the pressure and temperature on a portable electronic device.

Tires of a vehicle running at high speeds with insufficient tire pressure will cause a dramatic increase in the temperature in the tires, leading to peeling and breaking of the tires. On the other hand, the service lives of the tires having a pressure higher than the standard value are shortened. Properly inflated tires not only enhance the functions and safety of the tires but save fuel and prolong the service lives. Thus, it is important to know the tire pressure to assure driving safety and to prong the service lives of the tires.

Currently available tire pressure detection devices include a tire pressure detector mounted in a tire and a data receiver/display receiving a signal indicative of the tire pressure from the tire pressure detector through wireless communication, and the tire pressure is displayed on the display.

However, the costs involved in independent research and development of the data receiver/display are high. The number of available types is limited, and the operation proceeds through a closed platform. Ordinary manufacturers can not provide updating of software and hardware.

Thus, a need exists for a novel tire-pressure signal transmitting device avoiding the above disadvantages.

### BRIEF SUMMARY OF THE INVENTION

The primary objective of the present invention is to provide a transmitting device for receiving the data of pressure from a tire pressure detector and for transmitting the data of pressure to a portable electronic device.

To fulfill the above objective, a tire-pressure signal transmitting device according to the present invention includes a tire pressure detector adapted to be mounted in a tire of a vehicle. The tire pressure detector is adapted to detect pressure in the tire. A transmitting device includes a data receiver and a wireless transmitter. The data receiver receives data containing pressure of the tire detected by the tire pressure detector. The wireless transmitter is connected to the data receiver by a transmission interface. The transmission interface converts the data from the data receiver into a signal indicative of the data and sends the signal to the wireless transmitter. The wireless transmitter sends out the signal indicative of the data. A portable electronic device receives the signal sent by the wireless transmitter, allowing a user of the portable electronic device to know the pressure of the tire.

Other objectives, advantages, and novel features of the invention will become more apparent from the following detailed description when taken in conjunction with the accompanying drawings.

### DESCRIPTION OF THE DRAWINGS

FIG. 1 shows a block diagram illustrating a tire-pressure signal transmitting device according to the present invention.

FIG. 2 shows a schematic perspective view illustrating a vehicle using the tire-pressure signal transmitting device of FIG. 1.

FIG. 3 shows a partial, perspective view of an interior of the vehicle of FIG. 2.

### DETAILED DESCRIPTION OF THE INVENTION

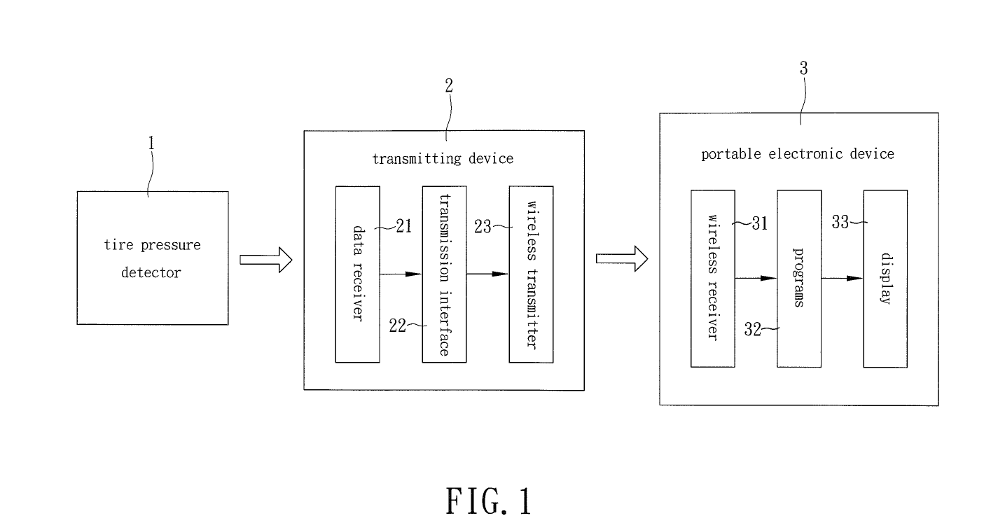

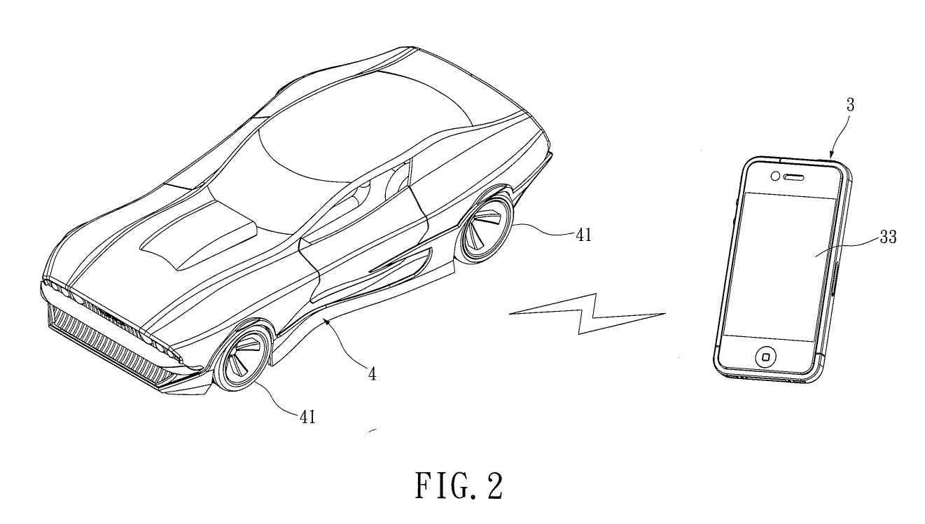

With reference to FIGS. 1 and 2, a tire-pressure signal transmitting device according to the present invention generally includes a tire pressure detector 1, a transmitting device 2, and a portable electronic device 3.

The tire pressure detector 1 is mounted in a tire 41 of a vehicle 4 for detecting the pressure and temperature of the tire 41. Data containing the pressure and temperature of the tire 41 is transmitted through wireless communication.

The transmitting device 2 includes a data receiver 21 and a wireless transmitter 23 connected to the data receiver 21 via a transmission interface 22. The data receiver 21 receives the data containing the pressure and temperature of the tire 41 sent by the tire pressure detector 1. The transmission interface 22 can be a universal asynchronous receiver transmitter (UART) or a universal serial bus (USB). Alternatively, the transmission interface 22 can be a serial peripheral interface (SPI). The data containing the pressure and temperature of the tire 41 received by the data receiver 21 is converted by the transmission interface 22 into a signal to be sent by the wireless transmitter 23. The wireless transmitter 23 can be a Bluetooth or WiFi with 2.4 GHz for wirelessly transmitting the signal indicative of the pressure and temperature of the tire 41 converted from the data by the transmission interface 22.

The portable electronic device 3 can be a notebook, mobile phone, mini-notebook, smart phone, or tablet personal computer. A wireless receiver 31 is built in the portable electronic device 3. The wireless receiver 31 can be a Bluetooth module or a WiFi card corresponding to the wireless transmission of the wireless transmitter 23. Furthermore, the portable electronic device 3 includes programs 32 for processing the data and a display 33.

When the tire pressure detector 1 detects the pressure and temperature of the tire 41, the data containing the pressure and temperature of the tire 41 is sent wirelessly to the data receiver 21, which, in turn, transmits the data to the transmission interface 22. The transmission interface 22 converts the data into a signal that is sent out by the wireless transmitter 23. When the wireless receiver 31 of the portable electronic device 3 receives the signal from the wireless transmitter 23, the programs 32 will display the data of the pressure and temperature of the tire 41 on the display 33 of the portable electronic device 3. The user can immediately know the pressure and temperature of the tire 41 of the vehicle 4.

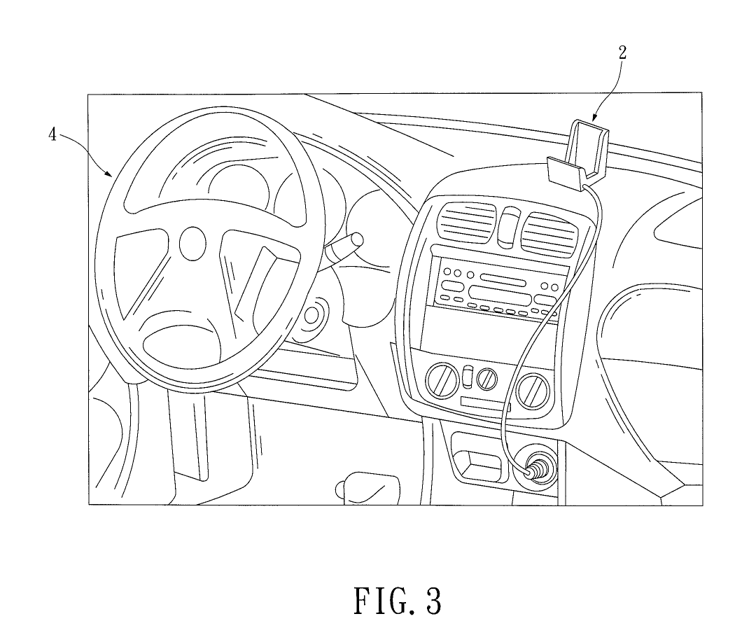

With reference to FIGS. 2 and 3, the transmitting device 2 according to the present invention can be in the form of a holder in the vehicle 4. The portable electronic device 3 can be held in the transmitting device 2. Furthermore, the transmitting device 2 can be electrically connected to a power of the vehicle 4. Alternatively, the transmitting device 2 can have its own power in the form of cells.

The present invention solves the disadvantages encountered in the prior art by using the transmitting device 2 to receive the data from the tire pressure detector 1 and to convert the data into a signal sent to the portable electronic device 3 that displays the pressure and temperature of the tire 41. The manufacturing costs of the transmitting device 2 are greatly cut, providing further functions for the portable electronic device 3 with the programs 32.

It can be appreciated that the tire pressure detector 1 can detect the pressure of the tire 41 only.

Although specific embodiments have been illustrated and described, numerous modifications and variations are still possible without departing from the essence of the invention. The scope of the invention is limited by the accompanying claims.

1. A tire-pressure signal transmitting device comprising:
a tire pressure detector adapted to be mounted in a tire of a vehicle, with the tire pressure detector adapted to detect pressure in the tire;
a transmitting device including a data receiver and a wireless transmitter, with the data receiver receiving data containing pressure of the tire detected by the tire pressure detector, with the wireless transmitter connected to the data receiver by a transmission interface, with the transmission interface converting the data from the data receiver into a signal indicative of the data and sending the signal to the wireless transmitter, with the wireless transmitter sending out the signal indicative of the data; and
a portable electronic device receiving the signal sent by the wireless transmitter, allowing a user of the portable electronic device to know the pressure of the tire.

2. The tire-pressure signal transmitting device as claimed in claim 1, wherein the transmission interface is a universal asynchronous receiver transmitter.

3. The tire-pressure signal transmitting device as claimed in claim 1, wherein the transmission interface is a universal serial bus.

4. The tire-pressure signal transmitting device as claimed in claim 1, wherein the transmission interface is a serial peripheral interface.

5. The tire-pressure signal transmitting device as claimed in claim 1, wherein the wireless transmitter is a Bluetooth wireless transmitter.

6. The tire-pressure signal transmitting device as claimed in claim 1, wherein the wireless transmitter is a WiFi transmitter.

7. The tire-pressure signal transmitting device as claimed in claim 1, wherein the portable electronic device is a notebook, mobile phone, mini-notebook, smart phone, or tablet personal computer.
